(19) United States
(12) Patent Application Publication
(10) Pub. No.: US 2009/0036327 A1
(43) Pub. Date: Feb. 5, 2009

(54) Method for chemical treatment of porous silicon surface

(75) Inventors: John Lawrence Ervin, San Diego, CA (US); Hus Tigli, La Jolla, CA (US); Mark R. Kennedy, South Burlington, VT (US)

Correspondence Address: TREX ENTERPRISES CORP., 10455 PACIFIC COURT, SAN DIEGO, CA, 92121, US

(73) Assignee: Trex Enterprises Corp.

(21) Appl. No.: 12/221,129

(22) Filed: Jul. 30, 2008

Related U.S. Application Data
(63) Continuation-in-part of application No. 11/180,349, filed on Jul. 13, 2005.
Application No. 11/180,349 is a continuation-in-part of application No. 10/631,592, filed on Jul. 30, 2003.
Application No. 10/631,592 is a continuation-in-part of application No. 10/616,251, filed on Jul. 8, 2003.
(60) Provisional application No. 60/962,652, filed on Jul. 30, 2007.
(60) Provisional application No. 60/962,616, filed on Jul. 30, 2007.
(60) Provisional application No. 60/962,664, filed on Jul. 30, 2007.
(60) Provisional application No. 60/962,756, filed on Jul. 30, 2007.
(60) Provisional application No. 60/962,675, filed on Jul. 30, 2007.
(60) Provisional application No. 60/962,669, filed on Jul. 30, 2007.
(60) Provisional application No. 60/962,644, filed on Jul. 30, 2007.
(60) Provisional application No. 61/127,910, filed on May 15, 2008.

(51) Int. Cl. C40B 50/18

(52) U.S. Cl. 506/32

(57) ABSTRACT

A method which renders the 3D surface of the insides of the pores of porous silicon biochip appropriate for conducting studies on biomolecule interactions without labels.

### CROSS-REFERENCE TO RELATED APPLICATIONS

This application claims the benefit of provisional patent applications Ser. Nos. 60/962,652, 60/962,616, 60/962,664, 60/962,756, 60/962,675, 60/962,669 and 60/962,644 all filed Jul. 30, 2007 and provisional patent application Ser. No. 61/127,910, filed May 15, 2008 and is a continuation in part of Ser. No. 11/180,349 filed Jul. 13, 2005, Ser. No. 10/631,592 filed Jul. 30, 2003 and Ser. No. 10/616,251 filed Jul. 8, 2003.

### FIELD OF INVENTION

This invention relates to methods for porous. to porous silicon and to method for preparing it for bio-molecular interaction studies.

### BACKGROUND OF THE INVENTION

### Optical Biosensors

An optical biosensor is an optical sensor that incorporates a biological sensing element. In recent years optical biosensors have become widely used for sensitive molecular binding measurements. To study interactions of proteins with other biomolecules one may generally use labeled or label-free methods. For these methods a first molecule of interest (the receptor) is immobilized onto a surface. An interaction is monitored by then introducing additional molecules (the targets) and detecting whether they in fact bind to the receptor. When using labels to monitor these interactions a fluorescent, colorimetric or some other signal is generated by an additional molecule or moiety that is attached to the target or receptor which gives a signal when the interaction takes place. This so called label (or tag) is present only to detect the interaction and is not part of the interaction of interest per se.

In label free binding, on the other hand, the receptor and target binding are monitored directly using untagged biomolecules. A variety of technologies exist in the art to detect binding without labels including surface plasmon resonance (SPR) and white light interferometery using porous silicon. In addition to the variety of technologies which exist to monitor label free binding events, there are a variety of instrument architectures which can used. These include plate readers and flow cells. In the case of plate readers a well plate (or micro well plate or micro titer plate) is used to house the biochips and fluids which are used for the label free binding studies. This allows for parallel analyses of several types of data. Alternatively flow cells house biochips in, typically, a microfluidic cell which routes fluid over the region of the biochip where the binding interaction takes place.

When acquiring and analyzing data of this sort there are a number of steps which are performed for the data analysis (the data method) on a number of channels (be those channels, flow cells or wells in a well plate). A file format which captures the full gamut of what a user of the analytical instrument might want to do must incorporate flexibility in acquisition and in analysis.

### Surface Plasmon Resonance

An optical biosensor technique that has gained increasing importance over the last decade is the surface plasmon resonance (SPR) technique. This technique involves the measurement of light reflected into a narrow range of angles from a front side of a very thin metal film producing changes in an evanescent wave that penetrates the metal film. Ligands and analytes are located in the region of the evanescent wave on the backside of the metal film. Binding and disassociation actions between the ligands and analytes can be measured by monitoring the reflected light in real time. These SPR sensors are typically very expensive. As a result, the technique is impractical for many applications.

### Resonant Mirror

Another optical biosensor is known as a resonant mirror system, also relies on changes in a penetrating evanescent wave. This system is similar to SPR and, like it, binding reactions between receptors and analytes in a region extremely close to the back side of a special mirror (referred to as a resonant mirror) can be analyzed by examining light reflected when a laser beam directed at the mirror is repeatedly swept through an arc of specific angles. Like SPR sensors, resonant mirror systems are expensive and impractical for many applications.

### Thin Films

It is well known that monochromic light from a point source reflected from both surfaces of a film only a few wavelengths thick produces interference fringes and that white light reflected from a point source produces spectral patterns that depend on the direction of the incident light and the index of refraction of film material. (See “Optics” by Eugene Hecht and Alfred Zajac, pg. 295-309, Addison-Wesley, 1979.)

### Porous Silicon Layers

U.S. Pat. No. 6,248,539 (incorporated herein by reference) discloses techniques for making porous silicon and an optical resonance technique that utilizes a very thin porous silicon layer within which binding reactions between ligands and analytes take place. The association and disassociation of molecular interactions affects the index of refraction within the thin porous silicon layer. Light reflected from the thin film produces interference patterns that can be monitored with a CCD detector array. The extent of binding can be determined from change in the spectral pattern.

### Kinetic Binding Measurements

Kinetic binding measurements involve the measurement of rates of association (molecular binding) and disassociation. Analyte molecules are introduced to ligand molecules producing binding and disassociation interactions between the analyte molecules and the ligand molecules. Association occurs at a characteristic rate [A][B]kₒₙ that depends on the strength of the binding interaction kₒₙ and the ligand topologies, as well as the concentrations [A] and [B] of the analyte molecules A and ligand molecules B, respectively. Binding events are usually followed by a disassociation event, occurring at a characteristic rate [A][B]k_{off} that also depends on the strength of the binding interaction. Measurements of rate constants kₒₙ and k_{off} for specific molecular interactions are important for understanding detailed structures and functions of protein molecules. In addition to the optical biosensors discussed above, scientists perform kinetic binding measurements using other separations methods on solid surfaces combined with expensive detection methods (such as capillary liquid chromatography/mass spectrometry) or solution-phase assays. These methods suffer from disadvantages of cost, the need for expertise, imprecision and other factors.

### Separations-Based Measurements

More recently, optical biosensors have been used as an alternative to conventional separations-based instrumentation and other methods. Most separations-based techniques have typically included 1) liquid chromatography, flow-through techniques involving immobilization of capture molecules on packed beads that allow for the separation of target molecules from a solution and subsequent elution under different chemical or other conditions to enable detection; 2) electrophoresis, a separations technique in which molecules are detected based on their charge-to-mass ratio; and 3) immunoassays, separations based on the immune response of antigens to antibodies. These separations methods involve a variety of detection techniques, including ultraviolet absorbance, fluorescence and even mass spectrometry. The format also lends itself to measure of concentration and for non-quantitative on/off detection assays.

### Porous Silicon Biochips

As described in the parent applications listed in the first paragraph of this specification, porous silicon biochips are fabricated in the form of a Fabry-Perot cavity where changes in the white light interference spectrum are used to deduce the time course of the biomolecular interaction. This porous silicon biochip is ideally suited for use with the non-invasive, non-destructive, label free white light probe. However, using the as formed, porous silicon surface would be inappropriate for such biochips for three reasons. First, the porous silicon surface is chemically unstable. That is it degrades under the buffer conditions typically used for biomolecular interaction studies. Second, it is difficult to immobilize the variety of receptors the researcher would want to study on the as formed porous silicon surface. Finally, targets and/or receptors could non-specifically bind to the surface, even if the interaction the research would like to study, are not present.

This last point, so called non-specific binding (NSB), is of particular concern when designing appropriate surface coverages for biosensor chips. In general what one wants to study in biomolecular interactions is the specific binding of one biomolecular to another molecule (which may or may not be a biomolecule). Any interaction which binds a molecule to the surface generates a signal. That is, the biochip readout instrument cannot generally distinguish between a specific binding event (between target and receptor, which is what the researcher wants to study) and between target and surface. A proper biochip surface coverage must minimize this later interaction.

What is needed is a method which fits all three requirements and is designed to meet the unique challenges of covering the surface of the high aspect ratio porous silicon pores.

### SUMMARY OF THE INVENTION

The present invention provides a method which renders the 3D surface of the insides of the pores of porous silicon biochip appropriate for conducting studies on biomolecule interactions without labels. The method includes a first step in which an as prepared Si—H surface is converted to a silica surface. This silica surface is then silanized in a process that coats the surfaces of the pores with silane. The silane coated surfaces are then coated with one of a variety of intermediate moieties for the purpose of minimizing non specific binding and to allow for easy immobilization of receptors. A preferred moiety are polymers cut from polyethylene glycol (PEG). Preferably the PEG molecules are of a variety of lengths between 4 and 60 monomer units.

### BRIEF DESCRIPTION OF THE DRAWINGS

FIG. 1A is a general description of the present invention.

FIGS. 1B and 1C are two preferred embodiments of the present invention.

FIG. 2 shows an example of a silanizing reagent (GOPTS).

FIG. 3 shows the reaction of GOPTS with the Silica surface.

FIG. 4 shows how the thickness of the GOPTS layer plateaus after a certain number of MVD half layers.

FIG. 5 shows an example hydrophilic reagent polyethylene glycol (PEG).

FIG. 6 shows the reaction of hetero bifunctional PEG with the silanized poSi chip

FIG. 7 shows the concept of variegated PEG length to increase surface density

FIG. 8 shows the preparation of an benzaldehyde surface using thiol chemistry

FIG. 9 shows a scheme for single point protein attachment to a surface using ex situ cross linking.

### DETAILED DESCRIPTION OF PREFERRED EMBODIMENTS

A preferred embodiment of the present invention is a method for preparing porous silicon chips for use in a biosensor described in parent patent applications Ser. No. 11/180,349 filed Jul. 13, 2005, Ser. No. 10/631,592 filed Jul. 30, 2003 and Ser. No. 10/616,251 filed Jul. 8, 2003 and Ser. No. ______ entitled “Optical Sensor and Methods for Measuring Molecular Binding Interactions” which is being filed simultaneously with this application. All of the above applications are incorporated herein by reference.

As described in the parent applications listed in the first paragraph of this specification, porous silicon biochips are fabricated in the form of a Fabry-Perot cavity where changes in the white light interference spectrum are used to deduce the time course of the biomolecular interaction. This porous silicon biochip is ideally suited for use with the non-invasive, non-destructive, label free white light probe. However, using the as formed, porous silicon surface would be inappropriate for such biochips for three reasons. First, the porous silicon surface is chemically unstable. That is it degrades under the buffer conditions typically used for bio-molecular interaction studies. Second, it is difficult to immobilize the variety of receptors the researcher would want to study on the as formed porous silicon surface. Finally, targets and/or receptors could non-specifically bind to the surface, even if the interaction the research would like to study, are not present.

This last point, so called non-specific binding, is of particular concern when designing appropriate surface coverages for biosensor chips. In general what one wants to study in bio-molecular interactions is the specific binding of one bio-molecular to another molecule (which may or may not be a bio-molecule). Any interaction which binds a molecule to the surface generates a signal. That is, the biochip readout instrument cannot generally distinguish between a specific binding event (between target and receptor, which is what the researcher wants to study) and between target and surface. A proper biochip surface coverage must minimize this later interaction.

The prior art has several examples of surface preparation for biosensors. These preparations however would not be applicable to the biosensor material here. Porous silicon contains pores which in the preferred embodiment have an aspect ratio in the range of 30-80 and have pore diameters near 80 nm. The solution phase methods taught in for example U.S. Pat. No. 5,436,161 would not successfully coat the insides of these pores. First, the as prepared poSi material is quite hydrophobic and is not amenable to thorough wetting by aqueous solutions. Second, the as prepared material is not stable to typical buffering conditions as the thin walls of the material are readily dissolved by solutions near neutral pH. Finally, material which reacts well with silica tends to also be susceptible to polymerization. This polymerization can easily clog the pores of the material and render it useless for label free biding studies.

Significantly, the Applicants have overcome the difficulties in applying the prior art—developed on materials with essentially an aspect ratio of zero (ie two dimensional surfaces), and applied it to a nano porous surface of aspect ratio 30-80. Indeed to call the work here surface preparation, enormously simplifies the nature of the ‘surface’ being prepared. The tortuous nature of poSi inordinately complicates the task of rendering the chips suitable for biosensor applications. However, the preferred embodiment below meets these challenges.

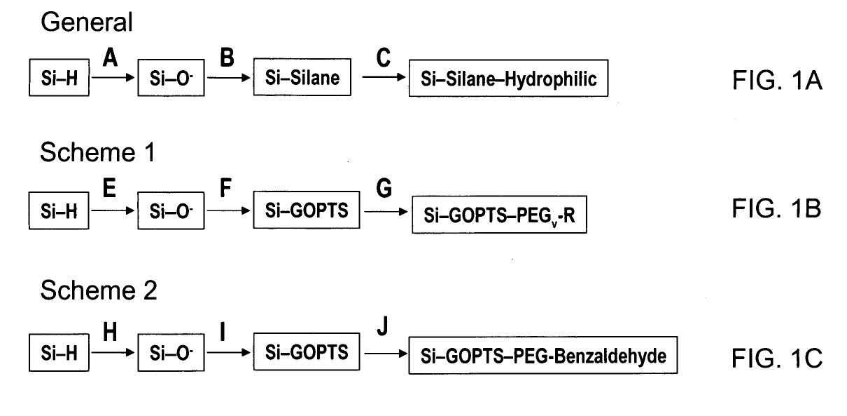

A preferred method for preparing the porous silicon chips for use in bio-molecular studies is described below. The general scheme is presents in FIG. 1A. This involves taking a hydrogen terminated silicon surface and turning it into silica (FIG. 1A-A). The silica is then protected with a silane (FIG. 1A-B) which generally leaves a hydrophic surface not easily reacted with aqueous reagents. This surface is then rendered hydrophilic (FIG. 1A-C) through where a number of molecules could be used.

Porous silicon biochips are formed by anodic etching in HF acid solution as described previously in the parent applications cited in the first paragraph of this specification which are incorporated herein by reference. This etching process leaves a surface where the silicon bonds are terminated with hydrogen as shown at A in FIG. 1A.

This Si—H surface may be converted to a silica surface as shown at B in FIG. 1 (A,E & H) by a variety of means including baking in an oxygenated atmosphere at 200° C., O₂ plasma cleaning, or soaking in water (with or without heat). Applicants' preferred technique is the baking process, though other processes are possible.

The Si—O⁻ surface is then silanized by coating it with a silane which protects the porous silicon surface from degradation as well as allows further reactions to take place. The proper method for silanizing the porous silicon surface must account for the high aspect ratio of the pores, which in the preferred embodiment ranges from 30-80. To accomplish this, a multi-step process is preferred which is designed to completely coat the pore surface, while avoiding self polymerization of the silane reagent.

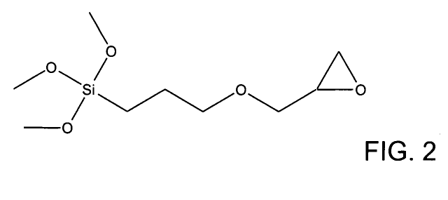

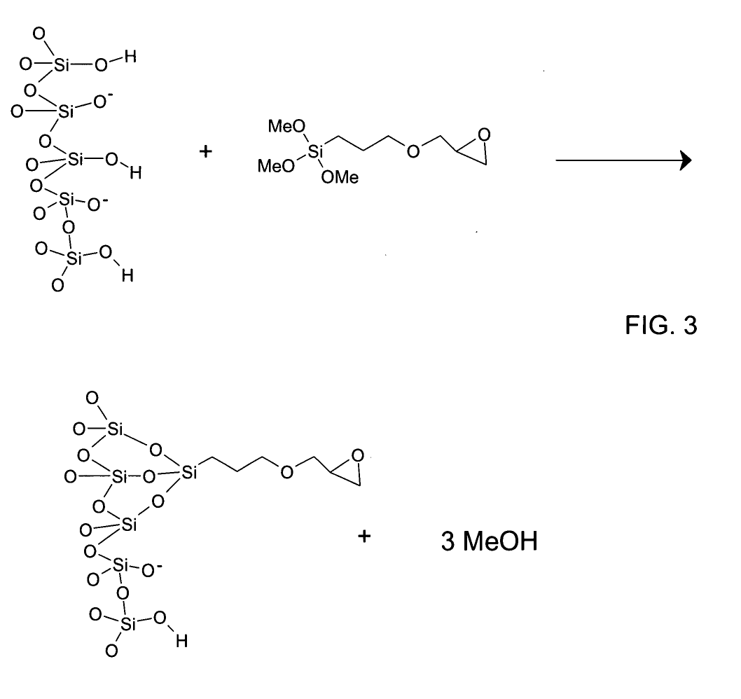

The crucial insight here is the applicants method for discovering how to properly coat a complete silane monolayer inside such a tortuous surface. In this preferred embodiment a tri-alkoxy silane (e.g. 3-glycidoxypropyl tri-methoxy silane—GOPTS see FIG. 2) is used and is deposited by molecular vapor phase deposition (MVD). In this embodiment an amount of GOPTS is introduced which is not enough to cover the entire surface. (FIG. 1 F & I) This GOPTS reacts with the surface as shown in FIG. 3.

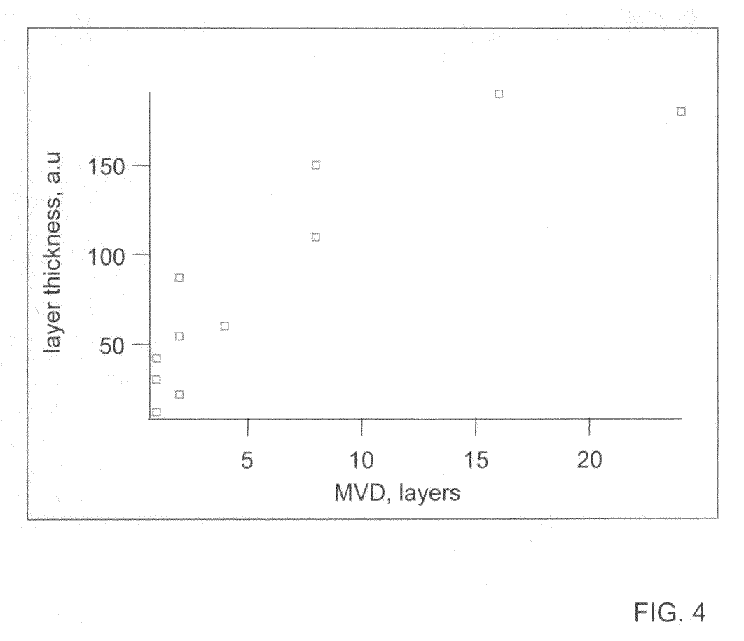

The GOPTS molecule has four reactive moieties and care needs to be taken to avod polymerizing the material. The applicants show that in order to avoid polymerization of the GOPTS, following each deposition the unreacted methoxy groups are hydrolyzed with water. Layers are built up in this way until a full monolayer of coverage is obtained. As shown in FIG. 4 building the layer up in this way causes a plateau of the layer thickness as a function of the number of MVD layers. That is when the full monolayer is properly formed, further GOPTS treatment will not grow the silane layer inside the pores as there are no longer any more reactive sites. In this way the surface is uniformly covered—even at high aspect ratio—without polymerizing the GOPTS which could clog the pores. One skilled in the art will recognize that other silanes or germanes could be used during this gas phase chemistry. In particular the scheme could be easily adapted to a number of tri-alkoxy silanes or tri alkoxy germanes.

After the MVD based silanization, the porous silicon biosensor chip is no longer susceptible to degradation under analysis conditions thereby meeting the first criterion of the necessary surface chemistry. However this 3D tortuous surface is not yet appropriate for biosensor readings as bio-molecules cannot be easily immobilized on the surfaces and there would be large amount of non-specific binding. For these last two criteria, step C of FIG. 1A is performed.

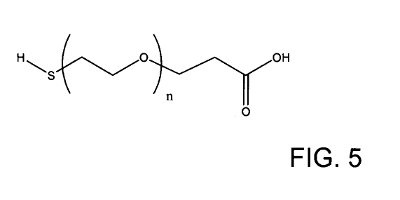

Here an epoxide group of the GOPTS is used to react one of a variety of ‘intermediate’ moieties whose purpose is to minimize non-specific binding and allow for easy immobilization of receptors. The preferred embodiment makes use of a polymer ‘cut’ from a polyethylene glycol reaction as indicated in FIG. 1B(G). In this embodiment in order to minimize non-specific binding PEG molecules of a variety of lengths are used with the mean PEG length (see n in FIG. 5) varied between 4-60 monomers.

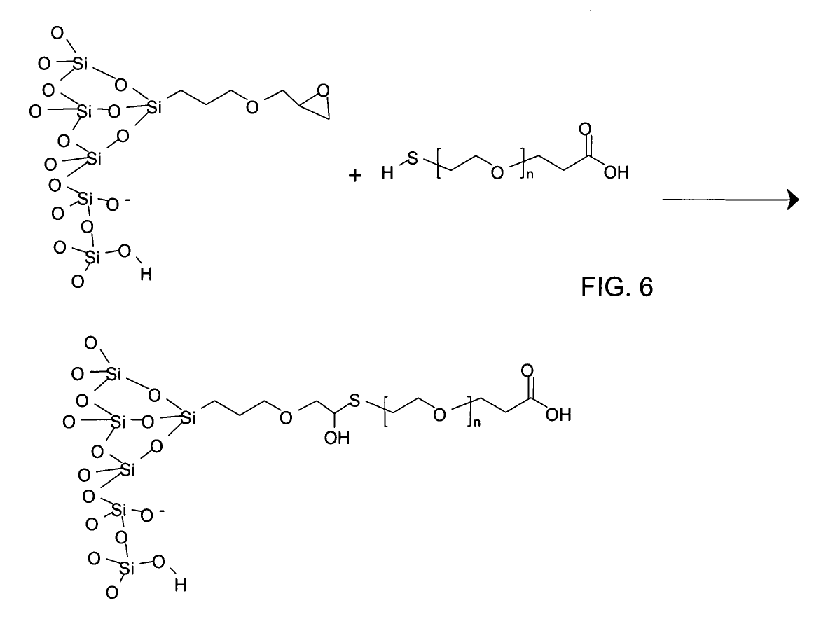

PEGs may be applied in a variety of ways to the silanized surface (see FIG. 6). The PEG molecules may be directly placed on the surface and then melted at high temperature (75-125° C.). Alternatively, the PEG molecules may be dissolved in an organic solvent such as di-methyl formamide (DMF) and spin cast on the wafer. The solvent is then removed by evaporation and the PEG reacts again with heat (75° C.). The applicant preferred embodiment is to use heat.

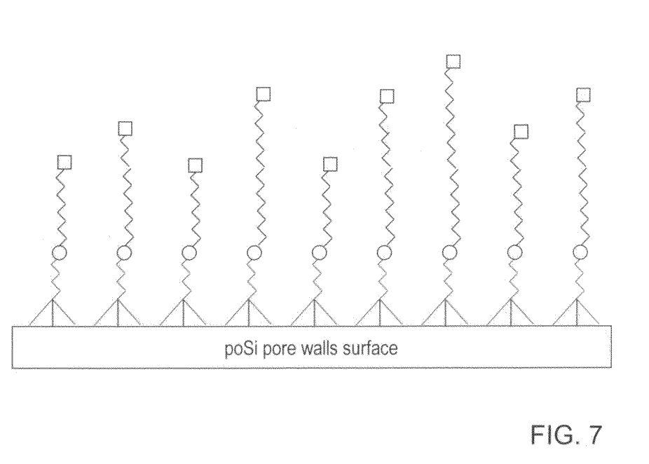

Though a set of discreet PEG molecules (those of uniform length) may be used the applicants have discovered that the variegated approach maximizes the amount of material that may be immobilized on the surface as shown in FIG. 7. The applicants believe that by immobilizing the molecules at different distances from the insides of the pore walls this allows for closer packing of the molecules used for the biosensing application. As more molecules may be immobilized, this allows the three dimensional surface described to be more sensitive.

The PEG ‘cuts’ (PEGᵥ, or variegated length PEGs) used in this implementation have a distribution of molecular weights. Indeed it is this fact which is crucial to minimizing the non-specific binding on the biosensor chip. The full width half max of the PEGᵥ distribution in the preferred implementation is 15-50% of n. More specifically n=60±15 is used showing very small NSB on GOPTS coated porous silicon biosensor chips with aspect ratios of 30-80.

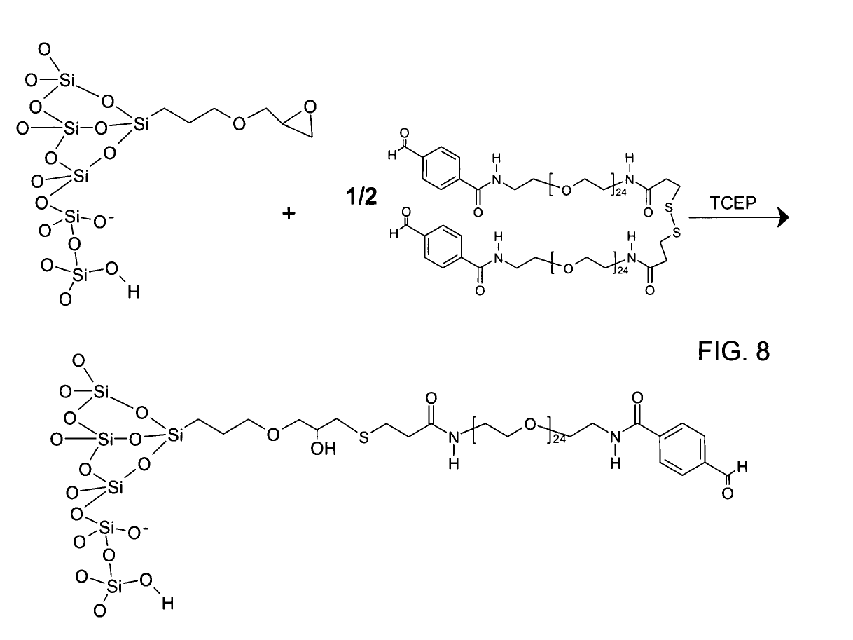

In this example the process leaves a carboxyl surface which can be used for immobilizing biomolecules through several R groups as shown at D in FIG. 1B. There are several ways described in the art for linking biomolecules to carboxyl groups including direct linking with primary amines (through succinimide ester of the carboxyl group) including cross linking schemes (e.g. hydrazone finctionalization of the carboxyl reacting with an aldehyde crosslinker on the biomolecules see e.g. U.S. Pat. No. 6,800,728 which is incorporated herein by reference see FIG. 1C. scheme 2). To make use of a hydrazone crosslinking scheme a different hetero-bifunctional PEG would be used to react with the epoxide. Though several PEG lengths are possible, the applicant's preferred embodiment is to use a 24 monomer length PEG which is synthesized in its dimeric form (FIG. 8). The disulfide is reduced with a slight excess of Tris(2-carboxyethyl) phosphine (hydrochloride) (TCEP) to give two of the free thiols. These thiols (FIG. 1-J) are reacted as the other hetero-bifunctional PEGs (FIG. 1-G).

In the preferred embodiment, the exposed benzaldehyde surface then reacts with molecules containing hydrazines to form a hydrazone bond, though other known reactants to aldehydes may also be used.

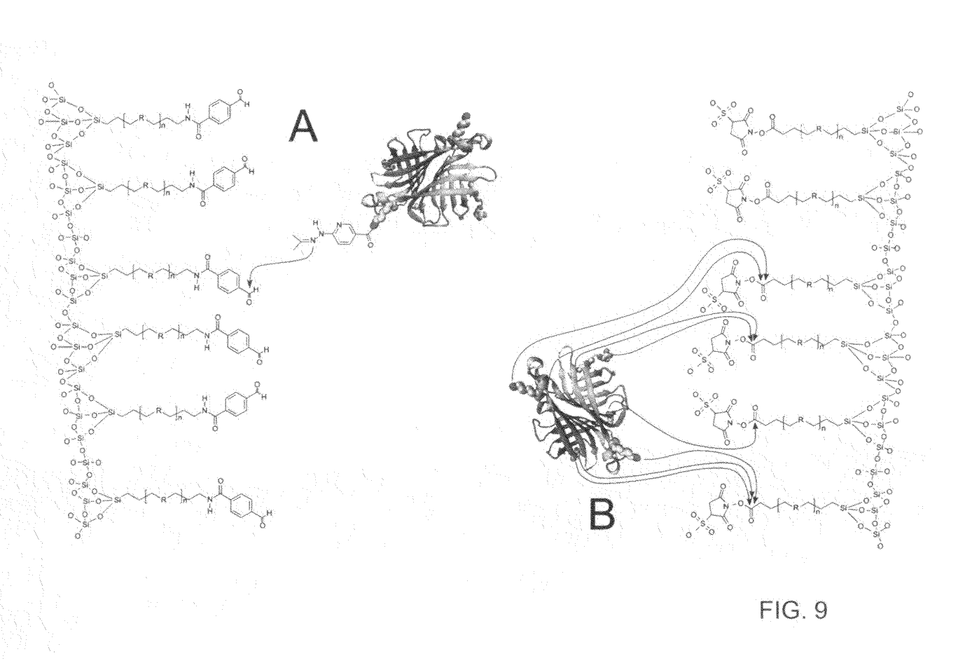

Significantly the Applicants have applied the hydrazine/benzaldehyde coupling scheme taught in U.S. Pat. No. 6,800,728 to help solve a major problem in porous silicon molecular interaction studies. The applicants here show how the hydrazone formation shown there may be used for label free binding for the first time. It is also the first application of this art on a tortuous, high aspect ratio 3D surface as is described here. Significantly this removes the known problem of multiple point attachment of the biomolecules. Looking at FIG. 9B one sees an amino coupling scheme known in the art for attachment to 2D surfaces. Here, as one can see on a protein with many amino groups as is shown, this leads to many potential attachment points to the surface which may decrease the activity of the protein.

Significantly, the applicants have developed a scheme for single point attachment (FIG. 9A). A protein is dissolved in 0.5 mL of water then equilibrated into phosphate buffered saline (PBS) buffer, pH 7.2, using ZEBA columns. 1 equivalent succinimidyl 6-hydrazinonicotinate acetone hydrazone (S-HyNic, SoluLink incorporation San Diego, Calif.) is dissolved in 0.03 mL anhydrous DMF. After complete solubilization of the S-HyNic reagent, 15 μL of the solution is added to the dissolved protein, followed by immediate rapid vortexing. After incubation of the crosslinking reaction at room temperature for 4 hours, the product was buffer exchanged into PBS, pH 6.0, using a ZEBA column.

This crosslinking approach, as it is performed at one equivalent, will react with only the most reactive moiety on the protein thereby allowing native protein to be used for the immobilization (as opposed to recombinantly introducing a cross linking point). The S-HyNic modified protein may then be introduced directly to the chip.

As an additional advantage of this, the applicants have discovered that a scheme like this obviates the need to activate each chip individually. As researchers are often interested in monitoring one receptor's behavior with regard to many targets, a researcher may use the crosslinking scheme described here to cross link large amounts of protein and then aliquot several portions of it for freezing. This ‘protein acitivation’ as opposed to chip activation, then needs to be performed only once for large amounts of receptor. The receptor may then be immobilized as needed by simply unfreezing one aliquot.

One skilled in the art will readily recognize that the scheme and methods described here for rendering the tortuous three dimensional structure of poSi suitable for biosensor studies may be modified to other chemistries. For instance other hetero-bifunctional reagents besides the PEG reagents described here may be used. This may include PEG reagents where one of the moieties is protected during deposition and then deprotected. For instance PEG may be used with a protected amino group (through for instance Cbz, tBoc, FMOC, benzylidene etc). After deposition the group may be removed and this amino moiety further reacted. Also one skilled in the art will immediately recognize that groups like maleimide, nitrilotriacetic acid, and immobilized protein chemistries (streptavidin, protein A, protein G etc.) can readily be prepared by extending this scheme.

What is claimed is:

1. A method for treating the inside surfaces of a porous silicon biochip initially having Si—H surfaces, comprising the steps of:
A) converting the Si—H surfaces to silica surfaces
B) silanizing the silica surface to produce silane surfaces
C) coating the silane surface with an intermediate moiety to minimize non specific binding

2. The method as in claim 1 wherein the intermediate moiety is a polymer cut from polyethylene glycol.

3. The method as in claim 1 wherein the intermediate moiety is a discreet version of polyethylene glycol with between 4 and 32 monomer units.

4. The method as in claim 1 wherein the silanizing agent is 3-glycidoxypropyl tri-methoxy silane.

5. The method as in claim 1 wherein the intermediate moiety is 4-formyl benzoate (polyethylene glycol)₂₄ thiol

6. The method as in claim 1 wherein the porous silicon biochip has pores diameters in the range of 10-250 nm and pore depths in the range of 500-5,000 nm

7. A method for immobilizing a biomolecule to biosensor surface through only a single point of attachment comprising the steps of:
A) preparing an aldehyde surface
B) crosslinking the biomolecule ex situ with a stoichiometric amount of a hydrazine or hydrazone containing moeity
C) reacting the cross linked molecule with the aldehyde surface
